(19) United States
(12) Patent Application Publication
(10) Pub. No.: US 2014/0355020 A1
(43) Pub. Date: Dec. 4, 2014

(54) DISPLAY CONTROL DEVICE, IMAGE PROCESSING APPARATUS, AND RECORDING MEDIUM

(71) Applicant: FUJI XEROX CO., LTD., Tokyo (JP)

(72) Inventors: Keiko SHIRAISHI, Kanagawa (JP); Kazuhiko NARUSHIMA, Kanagawa (JP); Masafumi ONO, Kanagawa (JP); Motofumi BABA, Kanagawa (JP); Koichi AZUMA, Kanagawa (JP); Hidenori HORIE, Kanagawa (JP); Kenji KUROISHI, Kanagawa (JP); Tsutomu NAKAMINATO, Kanagawa (JP); Yuri TAKEUCHI, Kanagawa (JP)

(73) Assignee: FUJI XEROX CO., LTD., Tokyo (JP)

(21) Appl. No.: 14/063,428

(22) Filed: Oct. 25, 2013

(30) Foreign Application Priority Data
Jun. 4, 2013 (JP) 2013-118177

(51) Int. Cl. H04N 1/00; G06K 15/00

(52) U.S. Cl. CPC H04N 1/00896; G06K 15/406
USPC 358/1.13

(57) ABSTRACT

A display control device includes a display device, a detector, and a prohibiting unit. The display device displays a consumed power value indicating power consumed by a processing section that operates on power supplied from a principal power source section. The detector operates on power from an auxiliary power source section that is different from the principal power source section to detect presence or absence of a mobile body within an area determined in advance. The prohibiting unit prohibits the display device from displaying the consumed power value for a period for which the detector is not detecting a mobile body or a part of the period.

### CROSS-REFERENCE TO RELATED APPLICATIONS

This application is based on and claims priority under 35 USC 119 from Japanese Patent Application No. 2013-118177 filed Jun. 4, 2013.

### BACKGROUND

(i) Technical Field

The present invention relates to a display control device, an image processing apparatus, and a recording medium.

(ii) Related Art

Image processing apparatuses transition between plural power modes to both maintain convenience of use and achieve energy saving by operating on a necessary minimum amount of power.

Examples of the power modes include (1) a print execution mode (power consumption: about 1000 to 1200 W), (2) a stand-by mode (power consumption: about 400 to 600 W), (3) a low-power mode (power consumption: about 100 to 150 W), (4) a sleep mode (power consumption: about 10 to 30 W), and (5) a controller off mode (power consumption: about 1 to 3 W).

### SUMMARY

According to an aspect of the present invention, there is provided a display control device including:

a display device that displays a consumed power value indicating power consumed by a processing section that operates on power supplied from a principal power source section;

a detector that operates on power from an auxiliary power source section that is different from the principal power source section to detect presence or absence of a mobile body within an area determined in advance; and

a prohibiting unit that prohibits the display device from displaying the consumed power value for a period for which the detector is not detecting a mobile body or a part of the period.

### BRIEF DESCRIPTION OF THE DRAWINGS

An exemplary embodiment of the present invention will be described in detail based on the following figures, wherein:

FIG. 1 is a schematic diagram of an image processing apparatus according to an exemplary embodiment;

FIG. 2 is an enlarge view of a portion of the image processing apparatus according to the exemplary embodiment around a user interface (UI);

FIG. 3 is a block diagram of a control system of the image processing apparatus according to the exemplary embodiment;

FIG. 4 is a flowchart illustrating a sub panel display control routine during a “sleep 0” mode according to the exemplary embodiment;

FIGS. 5A to 5D illustrate transition between states illustrating an example (operation pattern 2) of operation patterns associated with the display control based on the flowchart of FIG. 4;

FIGS. 6A to 6D illustrate transition between states illustrating an example (operation pattern 3) of the operation patterns associated with the display control based on the flowchart of FIG. 4;

FIG. 7 is a perspective view of an image processing apparatus according to Modification 1; and

FIG. 8 is a perspective view of an image processing apparatus according to Modification 2.

### DETAILED DESCRIPTION

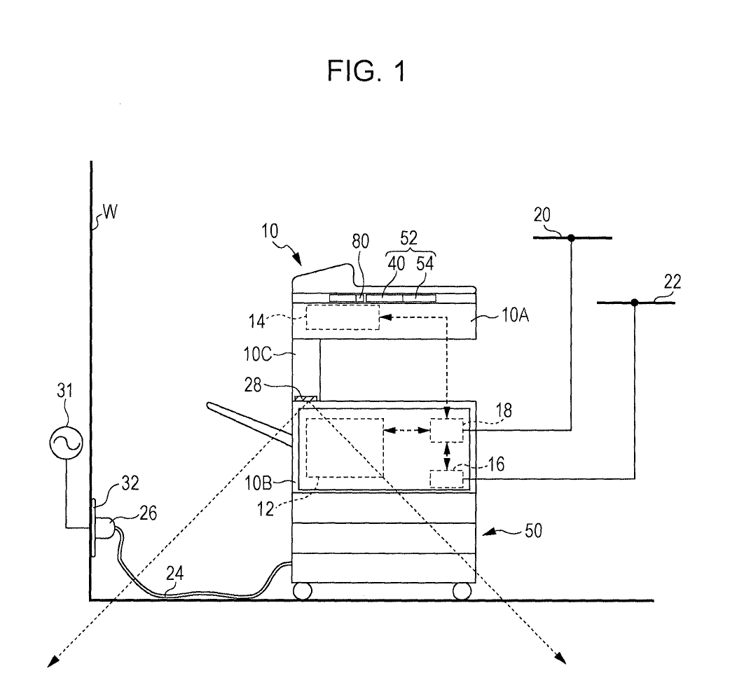

FIG. 1 illustrates an image processing apparatus 10 according to an exemplary embodiment.

The image processing apparatus 10 includes an image forming section 12 that forms an image on recording paper, an image reading section 14 that reads a document image, and a facsimile communication control circuit 16. The image processing apparatus 10 includes a main controller 18. The main controller 18 controls the image forming section 12, the image reading section 14, and the facsimile communication control circuit 16 so as to temporarily store image data on the document image read by the image reading section 14 and send the read image data to the image forming section 12 or the facsimile communication control circuit 16, for example. The image reading section 14 is covered by an upper housing 10A. The image forming section 12, the facsimile communication control circuit 16, and the main controller 18 are covered by a lower housing 10B. Plural tray units 50 that store recording paper are provided under the lower housing 10B.

A user interface 52 (hereinafter occasionally referred to as “UI 52”) is disposed on the upper surface and the front side of the upper housing 10A housing the image reading section 14. The UI 52 allows selecting an item from processing operations (services) including an image reading process, a copying process, an image forming process, and a transmission/reception process and making detailed settings for the processing operations, and displays the state of the image processing apparatus 10. The UI 52 is provided with a touch panel portion 40 that enables issuing a command by contacting the display screen using a finger of an operator or the like, and plural hardware keys 54 that enable issuing a command by a mechanical operation (for example, a pressing operation).

A sub panel 80 is provided adjacent to the touch panel portion 40. In the exemplary embodiment, the sub panel 80 functions as an independent user interface that does not belong to the UI 52.

A person detection sensor 28 is attached to a pillar portion 10C formed in a vertically long rectangular parallelepiped. The pillar portion 10C is a part of the housing of the image processing apparatus 10, and supports the image reading section 14. The person detection sensor 28 Will be discussed later.

A network communication line network 20 such as the Internet is connected to the main controller 18. A telephone line network 22 is connected to the facsimile communication control circuit 22. The main controller 18 is connected to a host computer via the network communication line network 20, for example, to receive image data, and executes facsimile reception and facsimile transmission using the telephone line network 22 via the facsimile communication control circuit 16.

The image reading section 14 is provided with a document platen for positioning of a document, a scanning drive system that radiates light to scan an image in the document placed on the document platen, and a photoelectric conversion element such as a CCD that receives reflected or transmitted light radiated by the scanning drive system to convert the light into an electrical signal.

The image forming section 12 includes a photoconductor. A charging device, a scanning exposure section, an image developing section, a transfer section, and a cleaning section are provided around the photoconductor. The charging device uniformly charges the photoconductor. The scanning exposure section performs scanning using a light beam on the basis of image data. The image developing section develops an electrostatic latent image formed through the scanning exposure performed by the scanning exposure section. The transfer section transfers the developed image on the photoconductor to recording paper. The cleaning section cleans the surface of the photoconductor after the transfer. A fixation section is provided on a transport path for the recording paper. The fixation section fixes the image on the recording paper after the transfer.

In the exemplary embodiment, services (processing forms) including scanning, copying, printing, facsimile transmission, facsimile reception, and post-reception printing may be executed using the image forming section 12, the image reading section 14, and the facsimile communication control circuit 16 (hereinafter occasionally referred to collectively as “devices”).

A receptacle 26 is attached to a distal end of an input power line 24 of the image processing apparatus 10. The receptacle 26 is inserted into a wiring plate 32 for a commercial power source 31 Wired to a wall surface W so that the image processing apparatus 10 is supplied with power from the commercial power source 31.

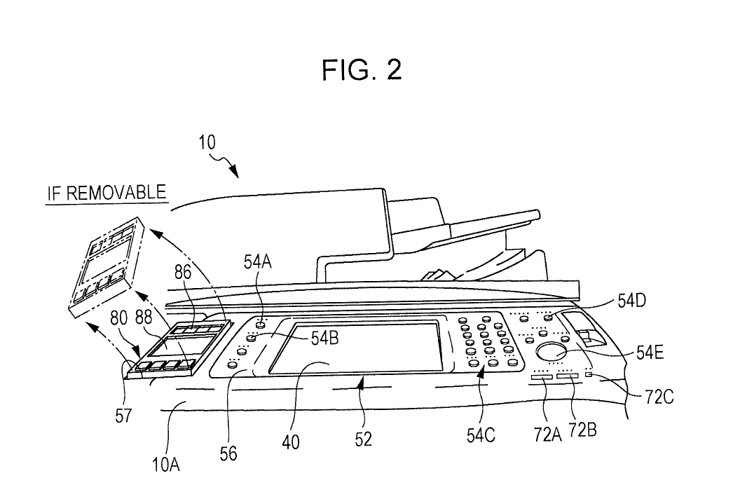

As illustrated in FIG. 2, the UI 52 provided on the upper housing 10A is provided on a plate 56 that is separate from the upper housing 10A. The touch panel portion 40 is disposed at the center portion of the plate 56. Plural hardware keys 54A to 54E (denoted collectively as hardware keys 54 in FIG. 1) are exposed to the left and right portions of the surface of the plate 56 in FIG. 2.

The hardware keys 54A to 54E are subjected to a pressing operation to establish a command determined in advance. Examples of the hardware keys 54A to 54E include a menu key 54A used to transition the display screen of the touch panel portion 40 to the basic screen, a copy key 54B used to command copying, numeric keys 54C used to specify the number of copies to be made or input a code number, a power conservation key 54D used to command start and end of power conservation, and a start key 54E used to command execution of a process.

Monitor LEDs 72A, 72B, and 72C are provided at the lower right of the plate 56 in FIG. 2 and in the vicinity of the start key 54E. The LED 72A indicates that data transmission is in progress. The LED 72B indicates occurrence of an error. The LED 72C indicates that power is turned on.

The sub panel 80 is provided on the left side of the plate 56 in FIG. 2. In the exemplary embodiment, the sub panel 80 is accommodated in a rectangular recessed portion 57 provided in the upper housing 10A.

A display section 88 is provided on the surface (the upper surface with the sub panel 80 accommodated in the recessed portion 57 as illustrated in FIG. 2) of a cover member that covers the entire sub panel 80.

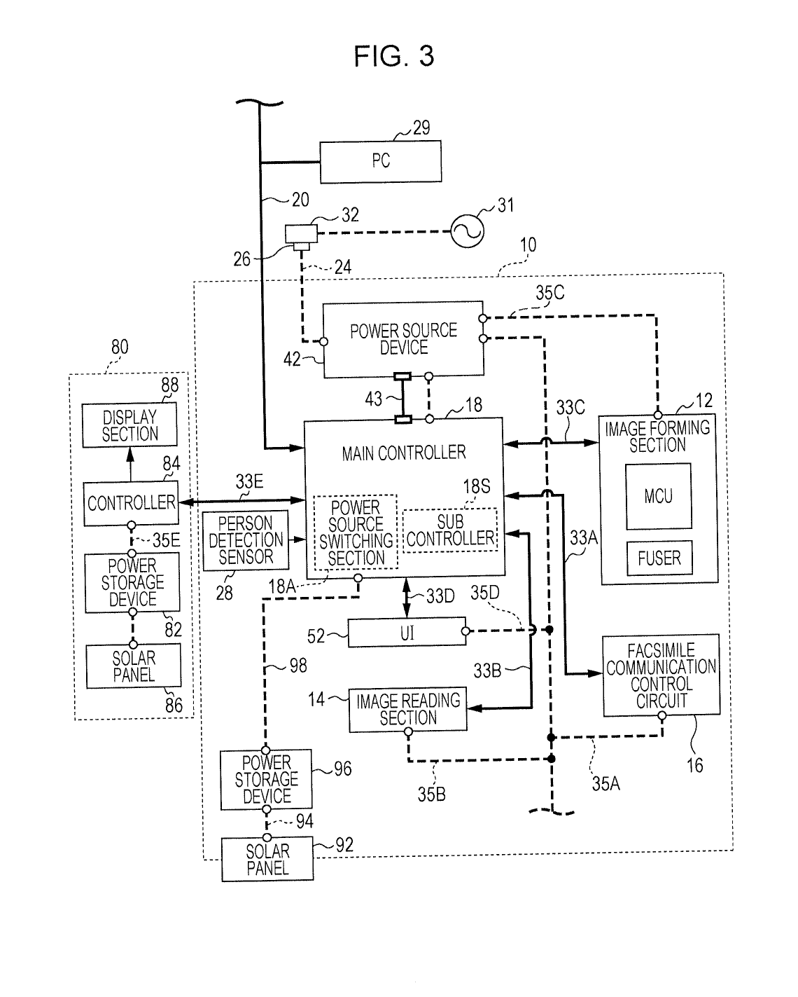

The sub panel 80 may be accommodated in the recessed portion 57 in a fixed manner or removably (see the phantom lines in FIG. 2). In the case where the sub panel 80 is removable, the wiring system corresponding to a bus 33E (see FIG. 3) for information communication between the image processing apparatus 10 and the sub panel 80 may be wired or wireless.

The attachment position of the sub panel 80 is not limited. The sub panel 80 may be attached to any of the upper housing 10A and the lower housing 10B, not to mention around the UI 52. The attachment position of the sub panel 80 may be selected such that the sub panel 80 is easily viewable from the user. In the case where the sub panel 80 is removable, plural locations may be provided for temporary attachment.

In the exemplary embodiment, the UI 52 and the sub panel 80 are provided separately because the UI 52 and the sub panel 80 are supplied with power from different supply sources so that the sub panel 80 is supplied with power from a different system to indicate information to be conveyed even when power supply to the UI 52 is blocked.

(Control System of Image Processing Apparatus)

FIG. 3 is a schematic diagram of a hardware configuration of the control system of the image processing apparatus 10.

The network communication line network 20 is connected to the main controller 18 of the image processing apparatus 10. A PC (terminal apparatus) 29 that may transmit image data or the like is connected to the network communication line network 20.

The facsimile communication control circuit 16, the image reading section 14, the image forming section 12, and the UI 52 are connected to the main controller 18 via buses 33A to 33D, respectively, such as data buses and control buses. That is, the main controller 18 principally controls the various processing sections of the image processing apparatus 10.

The main controller 18 according to the exemplary embodiment is connected to a controller 84 of the sub panel 80 via the bus 33E.

The image processing apparatus 10 includes a power source device 42. The power source device 42 is connected to the main controller 18 through a signal harness 43.

The power source device 42 is supplied with power from the commercial power source 31 via the input power line 24 by way of the wiring plate 32 and the receptacle 26.

The power source device 42 is provided with power supply lines 35A to 35D that independently supply power to the main controller 18, the facsimile communication control circuit 16, the image reading section 14, the image forming section 12, and the UI 52. This enables the main controller 18 to perform so-called partial power conservation control by individually allowing (power supply mode) and restricting (energy saving mode) power supply to the various processing sections (devices).

The person detection sensor 28 is connected to the main controller 18. In the exemplary embodiment, a “pyroelectric sensor” is used as the person detection sensor 28.

The person detection sensor 28 (a pyroelectric sensor) according to the exemplary embodiment detects the presence or absence of a mobile body moving within a detection range around the image processing apparatus 10. For example, the person detection sensor 28 may detect that a mobile body has approached the image processing apparatus 10 With the image processing apparatus 10 in one state to trigger a transition into another state.

The person detection sensor 28, which is expected to “detect a person”, is named in accordance with its function in the exemplary embodiment, and may at least be capable of detecting a person. In other words, the person detection sensor 28 may detect mobile bodies other than persons. Thus, although the person detection sensor is occasionally mentioned as detecting a “person” in the following description, an animal, a robot, or the like that executes a given command in place of a person and that may be implemented in the future may also be detected by the person detection sensor. In the case where a special sensor capable of specifically detecting a person is provided, conversely, such a special sensor may be used. In the following description, a mobile body, a person, a user, etc. are treated as synonyms for the target to be detected by the person detection sensor 28, and differentiated as necessary.

(Sub Panel 80)

As illustrated in FIG. 3, the sub panel 80 is provided with its own power storage device 80. The power storage device 82 is connected to the controller 84 via a power supply line 35E. The power storage device 82 is charged through solar photovoltaic power generation performed by a solar panel 86.

The sub panel 80 is provided with a display section 88 that operates under control by the controller 84.

The display section 88 is a liquid crystal display device with no back light that is of the most energy-saving type currently available. However, the display section 88 may be provided with a back light or be an LED display section, depending on the amount of power that may be stored in the power storage device 82 or the power generation capacity of the solar panel 86. The display section 88 may also be of a touch panel type that provides an operation function.

As described above, the sub panel 80 is not supplied with power from the image processing apparatus 10 but operates on power received from an independent power source (the power storage device 82), and functions as an information display device that displays information to be conveyed (principally, power value information) on the display section 88 on the basis of operation information (including execution information and operation mode (state) information for the various devices, for example) received from the main controller 18 via the bus 33E.

(Person Detection Sensor 28)

The person detection sensor 28 according to the exemplary embodiment is designed to detect motion of a mobile body around (for example, in the range of 1 m to 5 m from) the image processing apparatus 10. In this case, the person detection sensor 28 is typically an infrared sensor (a pyroelectric sensor) that uses the pyroelectric effect of a pyroelectric element.

The most distinguished feature of the sensor used as the person detection sensor 28 Which uses the pyroelectric effect of a pyroelectric element is its large detection area (including a wide detection angle and a long detection distance). Because the sensor detects motion of a mobile body in accordance with temperature variations, the sensor does not detect the presence of a person if the person is stationary within the detection area. For example, in the case where a high-level signal is output when a person is moving, the signal is switched to a low-level signal if the person within the detection range becomes stationary.

The term “stationary” as used in the exemplary embodiment refers to a completely stationary state as in a still image captured by a still camera or the like as a matter of course. However, the term also refers to a state in which a person stops in front of the image processing apparatus 10 for the purpose of making an operation, for example. Thus, the term “stationary” allows slight motion in a range determined in advance (such as motion accompanying breathing) and movement of hands, feet, the neck, or the like.

If a person stretches himself or herself in front of the image processing apparatus 10 While waiting for the completion of a process such as image formation or image reading, for example, the person detection sensor 28 may detect the presence of the person.

Thus, rather than setting a threshold for the person detection sensor 28 to detect motion by defining the term “stationary”, the threshold may be set relatively roughly to a standard value so that the definition of the term “stationary” relies on the detection state of the person detection sensor 28 Which is based on the environment (such as the temperature and the humidity). That is, the threshold may be set experimentally or statistically at the location of installation of the apparatus so as to indicate that a person is moving when the person detection sensor 28 outputs one (for example, a high-level signal) of binary signals, and that a stationary state is established when a person is present within the detection area of the person detection sensor 28 and the other (for example, a low-level signal) of the binary signals is output.

The person detection sensor 28 according to the exemplary embodiment is designed to detect motion of a mobile body around (for example, in the range of 0 m to 5 m from) the image processing apparatus 10. The person detection sensor 28 may be a sensor that detects the presence or absence of a mobile body (such as a reflex sensor or a camera, for example) instead of a sensor that detects motion of a mobile body. From the viewpoint of power consumption, the pyroelectric sensor is preferable.

In the exemplary embodiment, as illustrated in FIG. 3, a power source system that utilizes solar photovoltaic power generation is used as an auxiliary power source section that supplies power to the main controller 18 during a “sleep 0” mode period.

That is, the image processing apparatus 10 is provided with a solar panel 92. The solar panel 92 may be affixed to the entirety or a part of the surface of the upper housing 10A or the lower housing 10B (see FIG. 1), or may be disposed away from the image processing apparatus 10.

The solar panel 92 is connected to a power storage device 96 via dedicated wiring 94. Power charged in the power storage device 96 may be sent to the main controller 18 via a power supply line 98.

The main controller 18 is provided with a power source switching section 18A and a sub controller 18S. The power source switching section 18A switches the power supply source to the power source device 42 (the principal power source section) during a normal mode, and to the power storage device 96 (the auxiliary power source section) during the “sleep 0” mode.

The sub controller 18S performs some of the functions of the main controller 18, and is started during the “sleep 0” mode period to execute programs for monitoring the operation state of the power conservation key, standing by to receive information from the outside, and returning from the “sleep 0” mode to the normal mode.

The sub controller 18S may be provided separately from the main controller 18.

(Energy Saving Mode)

In processing devices including the image processing apparatus according to the exemplary embodiment, in a common energy saving mode, power supply to the devices other than the main controller 18 is blocked, and power other than power required for the function of standing by to receive information from the outside (such as the network communication line network 20 and the telephone line network 22) is blocked in the main controller 18. In this case, a power of about 1.5 W to 5 W is consumed.

In the exemplary embodiment, in contrast, the “sleep 0” mode in which power supply to the main controller 18 is basically blocked is used as the energy saving mode.

The phrase “power supply is basically blocked” indicates that the main controller 18 does not receive power at all from the commercial power source 31 (the power source device 42) but receives power from the auxiliary power source section that is separate from the power source device 42 serving as the principal power source section in order for the function of standing by to receive information from the outside and to return from the “sleep 0” mode to the normal mode. The power consumed in the “sleep 0” mode is 0.1 W or less in contrast to the common consumed power (1.5 W to 5 W). The display section 88 of the sub panel 80 is capable of displaying an indication of the power consumed during the “sleep 0” mode as one element of the information to be conveyed.

In the exemplary embodiment, the display section 88 displays a power value in the unit of 1 W. Thus, the consumed power of less than 1 W is displayed as “0 W” during the “sleep 0” mode.

The indication of a power value on the sub panel 80 (in particular, the indication of “0 W” during the “sleep 0” mode) enables a person present around the image processing apparatus 10 (in the range in which the display on the sub panel 80 is viewable) to recognize that the power consumed by the image processing apparatus 10 is “0 W” when the person turns his or her eyes to the sub panel 80.

In other words, there is no point in displaying an indication on the display section 88 of the sub panel 80 When there is no person present around the image processing apparatus 10.

Thus, in the exemplary embodiment, an indication of “0 W” is displayed on the display section 88 of the sub panel 80 during the “sleep 0” mode and on condition that the person detection sensor 28 is detecting a mobile body.

The term “person” refers to not only a user that is going to use the image processing apparatus 10 but also a person that just passes around the image processing apparatus 10.

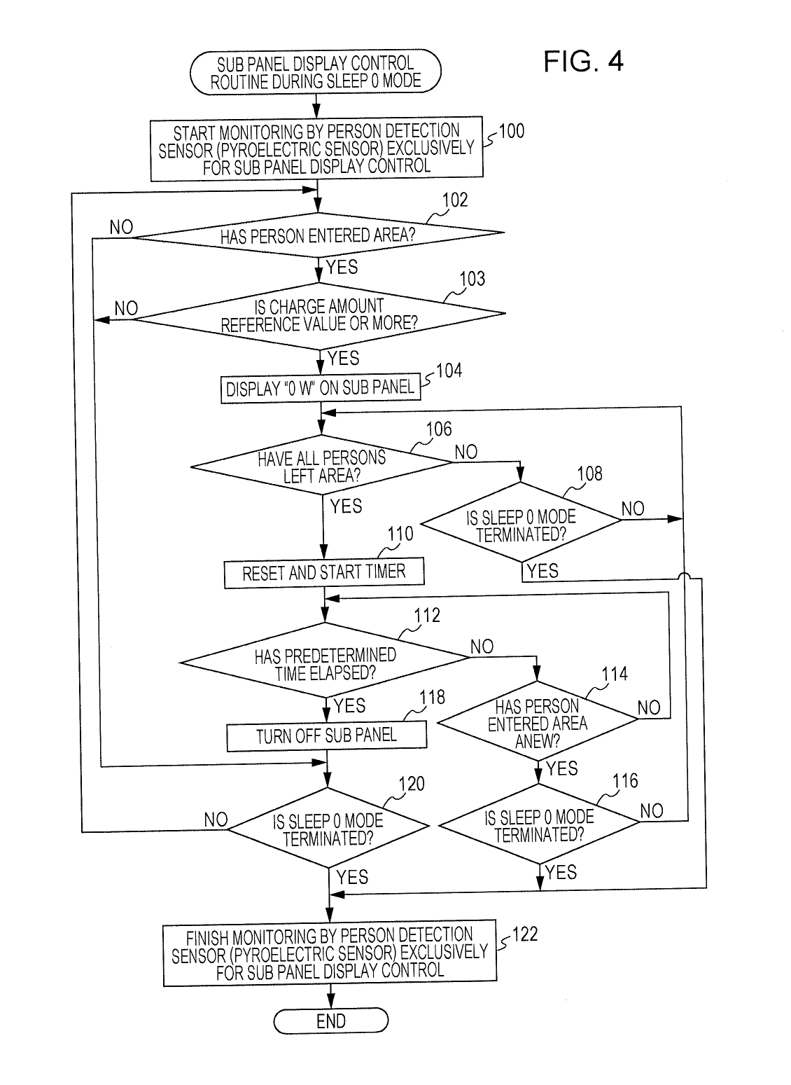

The operation of the exemplary embodiment will be described below with reference to the flowchart of FIG. 4.

The flowchart of FIG. 4 is started when the “sleep 0” mode is entered. First, in step S100, the person detection sensor 28 Which controls display on the sub panel 80 starts monitoring.

Then, in step S102, it is determined whether or not a person has entered the detection area of the person detection sensor 28. If the result of the determination is positive, the process proceeds to step S103. If the charge amount of the power storage device 82 is equal to or more than a reference value (if the result of the determination in step S103 is positive), the process proceeds to step S104. An indication of “0 W” is displayed on the display section 88 of the sub panel 80. The process proceeds to step S106.

If the result of the determination in step S102 or step S103 is negative, the process proceeds to step S120 to be discussed later.

In step S106, it is determined whether or not all the persons have left the detection area of the person detection sensor 28. If the result of the determination is negative, the process proceeds to step S108. In step S108, it is determined whether or not the “sleep 0” mode has been terminated. If the result of the determination is negative, the process returns to step S106. Step S106 and step S108 are repeated until the result of the determination in step S106 or step S108 becomes positive.

If the result of the determination in step S106 is positive, it is determined that no person is present within the detection area of the person detection sensor 28. The process proceeds to step S110. A timer for turning off the indication is reset and started. The process proceeds to step S112. If the result of the determination in step S108 is positive, the process proceeds to step S122 to be discussed later.

In step S112, it is determined whether or not a predetermined time has elapsed. If the result of the determination is negative, the process proceeds to step S114. It is determined whether or not a person has entered the detection area of the person detection sensor 28 anew.

If the result of the determination in step S114 is negative, the process proceeds to step S116. It is determined whether or not the “sleep 0” mode has been terminated. If the result of the determination in step S116 is negative, the process proceeds to step S106 to repeat the positive determination.

If it is determined in step S112 that a predetermined time has elapsed, the process proceeds to step S118. The indication on the display section 88 of the sub panel 80 is turned off. Then, the process proceeds to step S120. It is determined whether or not the “sleep 0” mode has been terminated. If the result of the determination in step S120 is negative, the process returns to step S102.

If the result of the determination in step S120 is positive, the process proceeds to step S122. The person detection sensor 28 Which controls display on the sub panel 80 finishes monitoring. The routine is thus terminated.

In the flowchart illustrated in FIG. 4, a power value is displayed on the display section 88 When a person has entered the detection area of the person detection sensor 28 on condition that power that is equal to or more than the reference value is charged in the power storage device 82 of the sub panel 80, and the power value once displayed is continuously displayed until turned off. However, the determination as to whether or not to display a power value on the display section 88 Which is made on the basis of the charge amount may be performed as an interrupt process provided separately from the flowchart of FIG. 4. If the determination is made as an interrupt process, the charge amount of the power storage device 82 may be monitored at all times, and an interrupt may be caused when the charge amount becomes less than the reference value to turn off the power value being displayed on the display section 88.

### Operation Pattern Examples

Operation examples based on the flowchart of FIG. 4 Will be described below.

“Operation Pattern 1”

When a person does not enter the detection area (with no indication on the sub panel), a sequence of step S100, step S102, step S103, step S120, step S102, . . . is taken in the flowchart of FIG. 4.

The absence of a person around the image processing apparatus 10 is rephrased as the absence of a person that sees an indication on the sub panel 80.

“Operation Pattern 2”

When a person once enters the detection area and keeps staying in the detection area (with an indication continuously displayed on the sub panel) to perform a process using the image processing apparatus 10, a sequence of step S100, step S102, step S103, step S104, step S106, step S108, and step S106 is taken in the flowchart of FIG. 4.

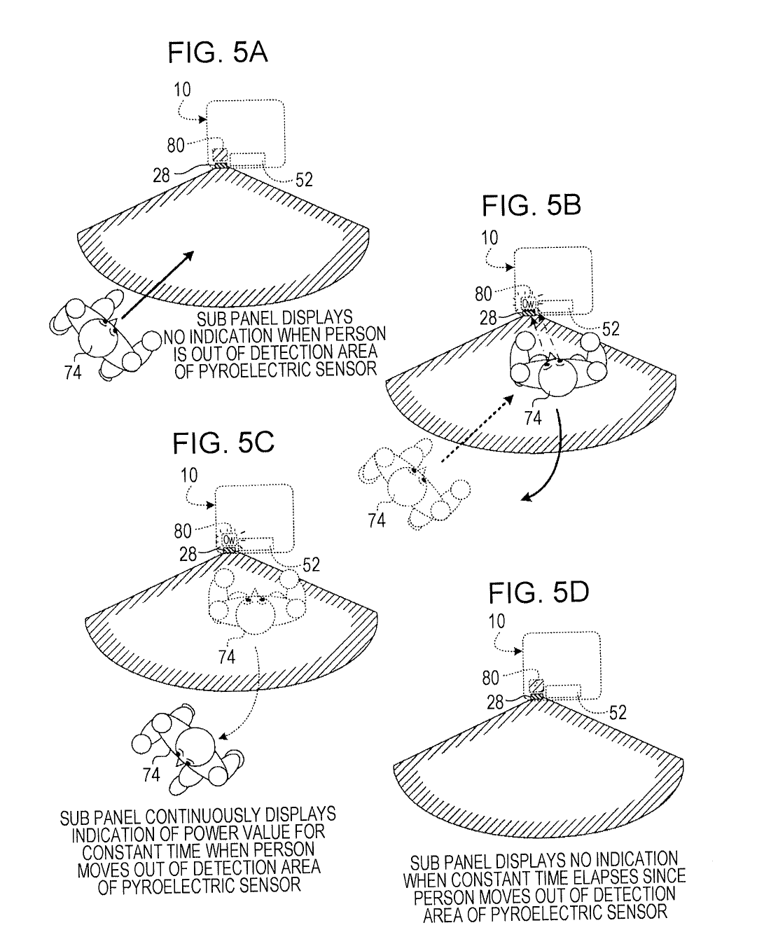

FIGS. 5A to 5D illustrate the operation pattern 2. A person 74 serving as a mobile body walks from outside the detection area of the person detection sensor 28 into the detection area (see FIG. 5A). At this time, no indication is displayed on the display section 88 of the sub panel 80. After that, when the person 74 Walks into the detection area of the person detection sensor 28, an indication of “0 W” is displayed on the display section 88 of the sub panel 80. The person 74 executes work such as commanding a process in front of the UI 52 of the image processing apparatus 10, and visually observes the indication of “0 W” (see FIG. 5B).

When the work is finished and the person 74 Walks out of the detection area of the person detection sensor 28 (see FIG. 5C), the indication of “0 W” on the display section 88 of the sub panel 80 is continuously displayed for a while (a predetermined time determined in advance). When the predetermined time has elapsed, the indication on the display section 88 of the sub panel 80 is turned off (see FIG. 5D).

“Operation Pattern 3”

The operation pattern 3 corresponds to a case where a person enters the detection area and just walks away (with an indication displayed on the sub panel for a constant time) in the flowchart of FIG. 4.

A sequence of step S100, step S102, step S103, step S104, step S106, step S110, step S112, step S118, step S120, step S102, . . . is taken.

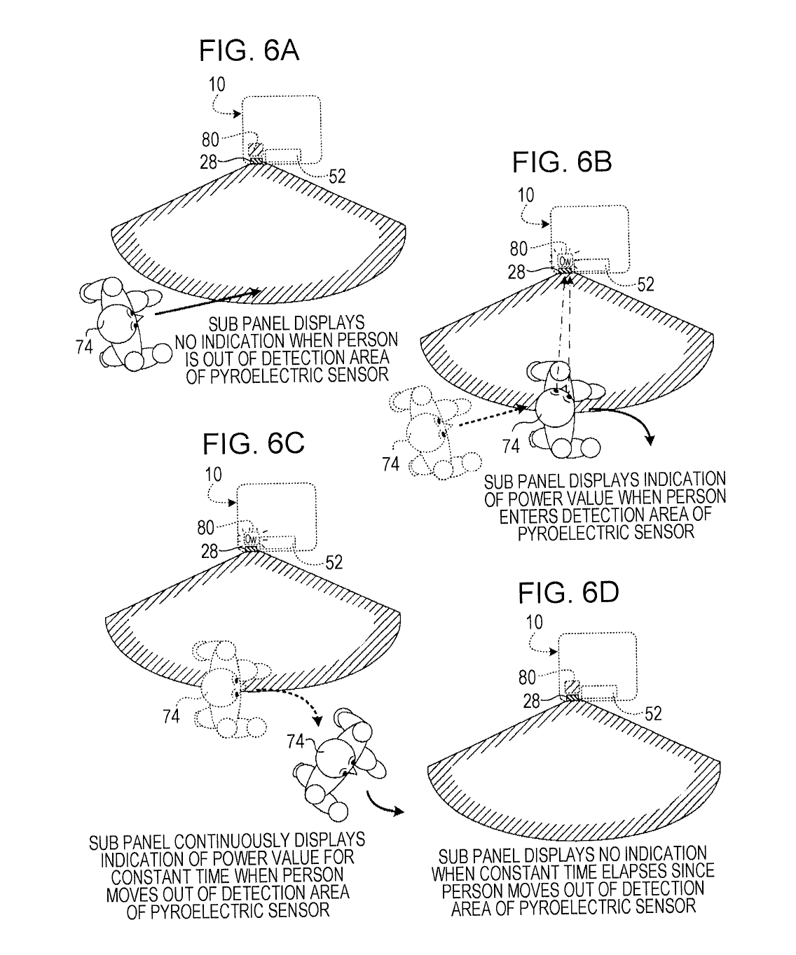

FIGS. 6A to 6D illustrate the operation pattern 3. A person 74 serving as a mobile body walks from outside the detection area of the person detection sensor 28 into the detection area (see FIG. 6A). At this time, no indication is displayed on the display section 88 of the sub panel 80. After that, when the person 74 Walks into the detection area of the person detection sensor 28, an indication of “0 W” is displayed on the display section 88 of the sub panel 80. The person 74 visually observes the indication while walking (see FIG. 6B).

After that, the person 74 Walks out of the detection area of the person detection sensor 28 Without approaching the image processing apparatus 10 (see FIG. 6C). At this time, even when the person 74 Walks out of the detection area of the person detection sensor 28, the indication of “0 W” on the display section 88 of the sub panel 80 is continuously displayed for a while (a predetermined time determined in advance). When the predetermined time has elapsed, the indication on the display section 88 of the sub panel 80 is turned off (see FIG. 6D).

“Operation Pattern 4”

In the flowchart of FIG. 4, an indication of “0 W” is displayed on the display section 88 of the sub panel 80 When the person 74 enters the detection area of the person detection sensor 28, and the timer for turning off the indication on the display section 88 is started when the person 74 once walks out of the detection area. In the case where the person 74 enters the detection area again or another person 74 enters the detection area before the timer expires, a sequence of step S100, step S102, step S103, step S104, step S106, step S110, step S112, step S114, step S116, step S106, . . . is taken to continuously display the indication on the display section 88 of the sub panel 80.

In controlling display on the display section 88 of the sub panel 80, when the detection area of the person detection sensor 28 is frequently visited, a smaller amount of power may be consumed by keeping the display turned on than by turning on and off the display repeatedly.

Therefore, the timing for turning off the display may be delayed for a period determined in advance to keep the display turned on until the next person 74 enters.

(Modifications)

“Modification 1”

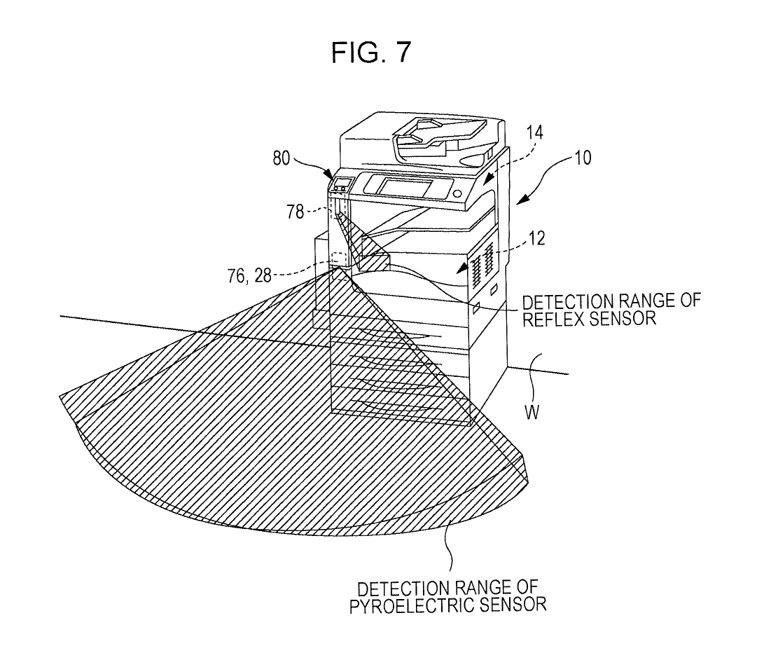

In the exemplary embodiment, the person detection sensor 28 (a pyroelectric sensor) is a sensor exclusively for displaying an indication of “0 W” on the display section 88 of the sub panel 80 during the “sleep 0” mode. However, for a power supply control system that executes power supply control by detecting stepwise a mobile body gradually approaching the image processing apparatus 10 using sensors with different detection ranges as illustrated in FIG. 7, one of the sensors used in the power supply control system may be utilized.

That is, in the power supply control system, a pyroelectric sensor is used as a first person detection sensor 76 for detection over a relatively wide range, and a reflex sensor is used as a second person detection sensor 78 for detection over a relatively narrow range. Therefore, a common sensor may be used as both the first person detection sensor 76 and the person detection sensor 28 according to the exemplary embodiment.

In the “sleep 0” mode, power is supplied to the first person detection sensor 76, but no power is supplied to the second person detection sensor 78. Power is supplied to the second person detection sensor 78 When the first person detection sensor 76 detects a mobile body.

When the second person detection sensor 78 detects the mobile body, power is supplied to principal devices such as the main controller 18 of the image processing apparatus 10.

In the case where a common sensor is used as both the person detection sensor 28 according to the exemplary embodiment and the first person detection sensor 76, the indication on the display section 88 of the sub panel 80 may not be “0 W” any more when the second person detection sensor 78 (a reflex sensor) is started. Thus, the detection area of the first person detection sensor 76 may be expanded compared to the detection area for a case where the first person detection sensor 76 is used exclusively for a power supply system to provide a time lag since detection until start of the reflex sensor. If a user keeps approaching the image processing apparatus 10, the second person detection sensor 78 Which is a reflex sensor is started.

“Modification 2”

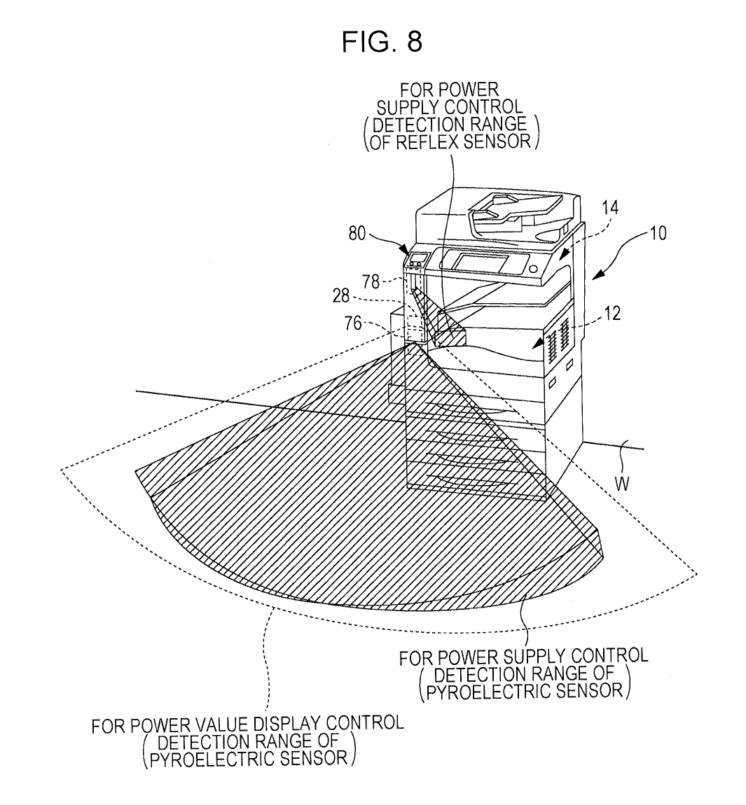

As illustrated in FIG. 8, a person detection sensor 28 for power value display control may be added to the image processing apparatus 10 in which the power supply control system which uses the first person detection sensor 76 and the second person detection sensor 78 is constructed to construct a display control system for the sub panel 80.

In this case, two pyroelectric sensors (the first person detection sensor 76 and the person detection sensor 28) and one reflex sensor (the second person detection sensor 78) are provided.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display control device comprising:
a display device that displays a consumed power value indicating power consumed by a processing section that operates on power supplied from a principal power source section;
a detector that operates on power from an auxiliary power source section that is different from the principal power source section to detect presence or absence of a mobile body within an area determined in advance; and
a prohibiting unit that prohibits the display device from displaying the consumed power value for a period for which the detector is not detecting a mobile body or a part of the period.

2. The display control device according to claim 1,
wherein the display device operates on power from an independent power storage device that is different from the principal power source section and the auxiliary power source section.

3. The display control device according to claim 1,
wherein the prohibiting unit allows the display device to continuously display the consumed power value for a period determined in advance since the detector does not detect the mobile body any more with the display device displaying the consumed power value.

4. An image processing apparatus comprising:
an image processing unit that operates on power supplied from a principal power source section to execute image processing on the basis of received information;
a transition unit that transitions between a normal mode in which the image processing unit may execute the image processing and a sleep mode in which the power supplied from the principal power source section is blocked and power required to return to the normal mode is supplied from an auxiliary power source section that is different from the principal power source section;
a detector that operates on power from the auxiliary power source section to detect presence or absence of a mobile body within an area determined in advance;
a display device that operates on power from an independent power storage device that is different from the principal power source section and the auxiliary power source section to display a consumed power value indicating power consumed by at least the image processing unit during the sleep mode; and
a prohibiting unit that prohibits the display device from displaying the consumed power value for a period for which the detector is not detecting a mobile body or a part of the period.

5. The image processing apparatus according to claim 4,
wherein the image processing unit comprises:
an image reading section that reads a document image;
an image forming section that forms an image on recording paper on the basis of the received information;
a communication circuit section that transmits and receives image information via a communication line network; and
a process controller that controls execution of the image processing performed using at least one of the image reading section, the image forming section, and the communication circuit section on the basis of a type of an image processing form selected from image processing forms including scanning, copying, printing, facsimile transmission, and facsimile reception.

6. A non-transitory computer readable medium storing a program causing a computer to execute a process for causing a display device to display a consumed power value indicating power consumed by a processing section that operates on power supplied from a principal power source section, the process comprising:
operating on power from an auxiliary power source section that is different from the principal power source section to detect presence or absence of a mobile body within an area determined in advance; and
prohibiting the display device from displaying the consumed power value for a period for which a mobile body is not detected or a part of the period.
